(19) United States
(12) Patent Application Publication
(10) Pub. No.: US 2013/0008315 A1
(43) Pub. Date: Jan. 10, 2013

(54) SYSTEM AND METHOD FOR ENERGY AND PARTICLE EXTRACTION FROM AN EXHAUST SYSTEM

(76) Inventors: DAWN WHITE, ANN ARBOR, MI (US); RANDY C. STEVENSON, SALINE, MI (US)

(21) Appl. No.: 13/542,582

(22) Filed: Jul. 5, 2012

Related U.S. Application Data
(60) Provisional application No. 61/504,585, filed on Jul. 5, 2011.

(51) Int. Cl. B03C 3/38

(52) U.S. Cl. 96/52; 96/77; 96/74

(57) ABSTRACT

A system for energy and particle extraction from an exhaust stream containing entrained particles, the system including an ionizer, a downstream collector, and an electrical couple. The ionizer is configured to charge the particles within the exhaust stream to a first charge polarity. The downstream collector is disposed downstream from the ionizer within the exhaust stream, and is configured to collect the charged particles. The electrical couple is configured to electrically couple a load between the ionizer and the downstream collector, wherein the load converts energy of the exhaust stream into electric power.

### CROSS-REFERENCE TO RELATED APPLICATIONS

This application claims the benefit of U.S. Provisional Application No. 61/504,585 filed 5 Jul. 2011, which is incorporated in its entirety by this reference.

This application is related to prior application Ser. No. 12/357,862, filed 22 Jan. 2009, titled “Electro-Hydrodynamic Wind Energy System,” prior PCT application number PCT/US09/31682, filed 22 Jan. 2009, titled “Electro-Hydrodynamic Wind Energy System,” and prior U.S. application Ser. No. 13/276,055, filed 18-Oct.-2011, titled “System And Method For Controlling Electric Fields In Electro-Hydrodynamic Applications,” which are incorporated in their entirety by this reference.

### TECHNICAL FIELD

This invention relates generally to the energy conversion field, and more specifically to a new and useful system and method in the energy conversion field.

### BACKGROUND

Exhaust systems are commonly used in industrial applications to remove unwanted process byproducts from a facility. Byproducts can include particulates or gasses, such as volatile organic compounds (VOCs). Exhaust systems typically entrain these byproducts in a fast-moving, hot fluid stream (e.g. air), which is typically exhausted into the environment. In doing so, contaminants are added to the environment and the thermal and kinetic energy of the exhaust stream are lost to the environment. Currently, no system exists that can extract the contaminants, the thermal energy, and the kinetic energy from the exhaust stream, and no system can be easily altered to fit exhaust systems. Conventional turbines can be used to convert kinetic energy into electricity, but the turbines' large weight and rotating loads are poorly suited to retrofit existing exhaust systems. Electrostatic precipitators can be used to remove particles from exhaust streams, but are energy intensive, requiring energy to create the high voltage difference needed to precipitate particles out of the gas stream.

Thus, there is a need in the electro-hydrodynamic energy conversion field to create a new and useful energy conversion system and method that extracts both the particles, the thermal energy, and the kinetic energy of the exhaust stream.

### BRIEF DESCRIPTION OF THE FIGURES

FIG. 1 is a schematic representation of a variation of the energy and particle extraction system.

FIG. 2 is a schematic representation of a second variation of the energy and particle extraction system.

FIG. 3 is a schematic representation of a variation of the ionizer including a variation of the particle conditioner.

FIGS. 4A and 4B are schematic representations of a first and second variation of the corona discharge device, respectively.

FIG. 5 is a schematic representation of a variation of the energy and particle extraction system including a positive corona discharge device.

FIG. 6 is a schematic representation of a variation of the energy and particle extraction system within a vertical flue.

FIG. 7 is a schematic representation of a variation of the energy and particle extraction system including a thermionic emitter.

FIG. 8 is a schematic representation of a variation of the energy and particle extraction system including a thermal energy extraction circuit and a kinetic energy extraction circuit.

FIGS. 9A, 9B, 9C, and 9D are a perspective view of a variation of the thermionic emitter, a cross section of a second variation of the thermionic emitter, a cross section of a third variation of the thermionic emitter, and a cross section of a fourth variation of the thermionic emitter, respectively.

FIGS. 10A, 10B, and 10C are perspective views of a first, second, and third variation of the downstream collector, respectively.

FIG. 11 is a schematic representation of a variation of the energy and particle extraction system including a shaping field.

FIG. 12 is a schematic representation of a variation of the energy and particle extraction system including a variation of the field shaper.

FIG. 13 is a schematic representation of a method of extracting energy and particles from the exhaust stream.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Energy and Particle Extraction

As shown in FIG. 1, the energy conversion system 100 for an exhaust stream 20 containing entrained particles ₄o includes an ionizer 140 configured to charge a particle within the exhaust stream 20 to a first polarity; a downstream collector 160 configured to collect the charged particle; and a load 180, electrically coupled between the ionizer 140 and the downstream collector 160, configured to convert the thermal and/or kinetic energy of the exhaust stream 20 into electric power. The ionizer 140 can additionally generate an electric field 60, wherein stream drag on the charged particle at least partially opposes the force of the electric field 60 on the particle. The ionizer 140 can additionally generate ions from the heat of the exhaust stream 20. The system 100 functions to extract energy from an exhaust stream 20, as well as remove the particles ₄o entrained within the exhaust stream 20. More specifically, the system 100 converts exhaust stream thermal energy into electrical energy. The system 100 can additionally convert exhaust stream kinetic energy into electrical energy. The energy conversion system 100 can be used, for example, with the exhaust stream of an automotive paint system which might contain approximately 10¹⁷ ppm of particulates and gaseous species, left behind by the regenerative thermal oxidizer, that are capable of carrying suitable amounts of charge while being moved by the drag forces present. Alternatively, the energy conversion system 100 can be used after a regenerative thermal oxidizer system, wherein the energy conversion system 100 uses the waste heat from the RTO process to charge water particle clusters generated from the RTO process; subsequent collection of the charges extracts energy from the system. The system 100 can remove a significant portion (if not substantially all) of these particles from the stream. The system 100 is preferably utilized within an exhaust system, more preferably within an exhaust flue 102 through which the exhaust stream 20 flows. The system 100 is preferably arranged near the exhaust outlet, wherein the exhaust stream 20 flows through the energy conversion system 100, but can alternatively be arranged near the exhaust inlet or in any other suitable position. The system 100 is preferably utilized in exhaust systems that demand high velocity exhaust, such that the waste has a large and potentially recoverable kinetic energy component. However, if the exhaust stream 20 includes excess kinetic energy, the system 100 can additionally include feedback mechanisms to control the exhaust stream speed (e.g. reducing kinetic energy waste by reducing the exhaust speed). The system 100 can alternatively/additionally be utilized in exhaust systems with high thermal load, such that the waste has a large and potentially recoverable thermal component. The exhaust stream 20 preferably contains entrained particles 40 and gases, and flows at an exhaust stream velocity. The exhaust stream flow is preferably highly collimated within the flue.

The energy conversion system 100 charges the entrained particles 40 and suitable gas molecules to create ionic species and/or charged particles, then collects the charged particles to extract energy from the system 100. The energy conversion system 100 can extract energy from the waste stream in two ways. First, the energy conversion system 100 can extract electrical energy from the thermal energy of the waste stream through thermionic emission, wherein the thermal energy within the waste stream does work on an emitter to excite ion emission from the emitter. Collection of the emitted ions creates a potential difference and enables electrical energy to be extracted from the system 100. The energy conversion system 100 leverages the principles of thermionic emission to harness the thermal energy within the exhaust stream and convert the thermal energy to electricity. In principle, the energy conversion system 100 leverages the thermal energy of a fluid stream to generate ions from a thermionic emitter 146, wherein the generated ions are carried by the entrained particles to the downstream collector 160. The energy conversion system 100 can further leverage the kinetic energy of the fluid stream to overcome the space charge generated at the thermionic emitter 146 by the emitted ions. Second, the energy conversion system 100 can extract electric energy from the kinetic energy of the waste stream, wherein exhaust stream moves the charged particles 42 against an applied electric field 60 that opposes charged particle collection at the downstream collector 160, thus generating work. The energy conversion system 100 leverages the principles of an electro-hydrodynamic system to harness the kinetic energy within a fluid stream and convert it to electricity. In principle, the energy conversion system 100 leverages the kinetic energy of a fluid stream to move a charged particle of a specific ionic species (created by the ionizer 140) against an applied electric field 60, created between the ionizer 140 and the downstream collector 160. This electric field 60 opposes the movement of the charged particle in the direction of fluid stream flow; upon moving the charged particle, the fluid stream performs work upon the system. The work of the fluid stream is preferably used to separate particles of opposing charges, wherein one species of charge 42 is entrained within the fluid stream and a second species of charge 44 (preferably complimentary to the first) is orphaned into a current. The entrained species 42 is preferably collected by the downstream collector 160, which charges the downstream collector 160, resulting in an increased potential difference between the ionizer 140 and the downstream collector 160. When the two collectors are electrically coupled together, a current flows between the collectors as a result of the potential difference. When a load 180 is coupled between the two collectors, useful work is harnessed from the potential difference. By charging the particles entrained within exhaust streams 20 and allowing the exhaust stream 20 to move the charged particles 42 against an opposing electric field 60, the energy conversion system 100 harnesses the kinetic energy of the exhaust stream 20 and collects the unwanted particles at the downstream collector 160. The energy conversion system 100 is differentiated over the electrostatic precipitator in that the working medium (e.g. exhaust stream) applies an electric field 60 that opposes charged particle movement; in contrast, an electrostatic precipitator applies an electric field 60 that promotes charged particle movement toward the downstream collector 160.

The ionizer 140 of the energy conversion system 100 functions to charge entrained particles flowing through the system to a single polarity. The ionizer 140 can additionally function to collect the charge species orphaned by particle charging. In some variations, the ionizer 140 can additionally generate an electric field 60 that exerts a force on the charged particles that opposes stream drag on the particle, wherein the ionizer 140 is preferably biased at an upstream potential that is preferably of the opposite polarity as the generated charged particles 42. Collection of the orphaned charge species can facilitate bias of the ionizer 140 at the upstream potential. The ionizer 140 is preferably biased at a negative potential relative to the downstream collector, but can alternatively be biased at a positive potential relative to the downstream collector. The ionizer 140 is preferably located upstream from the downstream collector 160. The ionizer 140 is preferably located within the exhaust stream 20, but can alternatively be located exterior the exhaust stream 20. The ionizer 140 preferably charges the entrained particles as the particles flow past the ionizer 140, but can alternatively capture the particles (e.g. through adsorption, filtration, etc.) and simultaneously charge and re-introduce the particles into the exhaust stream 20. However, any other suitable means of ionizing the particles can be used. The ionizer 140 preferably imparts positive charges to the particles and collects negative charges, but can alternatively impart negative charges and collect positive charges. The ionizer 140 is preferably formed as a mesh or a series of parallel wires, wherein the exhaust stream 20 flows past the ionizer 140, but can alternatively be a plate, have a toroidal formation (e.g. wherein the exhaust stream 20 flows through the center), or have any other suitable configuration. The ionizer 140 preferably performs both diffusion charging to charge small particles (on the scale of 1 micron or less) and field charging to charge large particles (on the scale of 2 microns or more) but can alternatively perform only diffusion charging or only field charging. The ionizer 140 preferably charges particles or groups of particles near the point at which the ratio between electrostatic and drag forces on the particle are equal, while ensuring that drag forces always exceed electrostatic forces for the specified wind stream (e.g. near the Paschen limit). For gaseous species, the charge should approach the point at which ion mobility and stream velocity are equal while allowing stream velocity to exceed ion mobility.

The ionizer 140 is preferably electrical ionizer, such as a corona discharge device 142, an induction charger (including, but not limited to, those disclosed in prior application Ser. No. 12/357,862, filed 22 Jan. 2009, titled “Electro-Hydrodynamic Wind Energy System,” and prior PCT application number PCT/US09/31682, filed 22 Jan. 2009, titled “Electro-Hydrodynamic Wind Energy System,” incorporated herein in their entirety), a fluid injector that injects charged fluid particles into the exhaust stream 20, or any suitable electrical ionizer that charges the particles flowing therethrough. Alternatively/additionally, the ionizer 140 can be a thermionic emitter. The corona discharge device 142 preferably ionizes the particles between the device and the downstream collector 160. The corona discharge device 142 preferably includes a high curvature electrode, such as a wire or a series of sharp points (e.g. a series of needles 144, as shown in FIGS. 4A and 4B, barbed wire, etc.), and a low curvature electrode, such as a plate. The corona discharge device 142 is preferably arranged perpendicular to the exhaust stream flow such that the high potential of the corona discharge device charges the particles flowing past. The high curvature electrode is preferably biased at a positive potential relative to the low curvature electrode, such that the corona discharge device 142 generates a positive corona. Alternatively, the high curvature electrode can be biased at a negative potential relative to the low curvature electrode, such that a negative corona is generated.

In one variation of the system 100, the corona discharge device includes a high curvature electrode and a low curvature electrode, wherein the potential difference between the high curvature electrode and the low curvature electrode generates the corona discharge. The low curvature electrode is preferably arranged collinear with the low curvature electrode, such that the low curvature electrode and high curvature electrode are arranged along the width or cross-section of the exhaust stream 20 (as shown in FIG. 5), but can alternatively be arranged downstream from the low curvature electrode, upstream from the low curvature electrode, or in any suitable orientation. The high curvature electrode can be a wire, needle, barbed wire, or any other suitable high curvature electrode. The low curvature electrode can be a substantially flat, prismatic plate, a slightly curved plate, the side of the flue 102, or any other suitable low curvature electrode. The high curvature electrode is preferably biased at a high positive potential, while the low curvature electrode is preferably grounded or biased at a negative potential. However, the electrodes can be biased at any suitable polarity. The low curvature electrode can additionally include localized shielding elements to prevent shorting to the low curvature electrode, which can be particularly desirable when the low curvature electrode is arranged downstream from the high curvature electrode. The shielding elements preferably generate an electric field that locally repels the charged particles 42 away from the low curvature electrode. The shielding elements preferably include one or more electrodes, biased at the same polarity as the high curvature electrode but at a lower potential, that is arranged between the high and low curvature electrodes proximal the low curvature electrode.

In another variation of the system 100, the downstream collector additionally functions as the low curvature electrode of the corona discharge device 142, wherein the potential difference between the high curvature electrode and the downstream collector generates the corona discharge. The high curvature electrode is preferably biased at a positive potential relative to the downstream collector 160 to form a positive corona, but can alternatively be biased at a negative potential to form a negative corona.

The ionizer 140 can alternatively and/or additionally include a thermionic emitter 146. The thermionic emitter 146 preferably generates ions upon application of a thermal load. The emitted ions are preferably positive ions, but can alternatively be negative ions, such as electrons. Positive ions can be directly emitted by the thermionic emitter 146, or can be generated through surface ionization, single electron impact, or stepwise ionization. When both a thermionic emitter 146 and a secondary ionizer 140 are used, the secondary ionizer and thermionic emitter 146 preferably produce ions of the same polarity, but can alternatively produce ions of opposing polarity (e.g. to control the space charge). In operation, the thermionic emitter 146 generates ions upon heating of the thermionic emitter 146 beyond the work function of the thermionic emitter 146. The emitted ions are entrained by the large number of particles within the exhaust stream. The energy contained within the emitted ions, in combination with the kinetic energy of the exhaust stream and the thermal expansion of the exhaust stream at the flue outlet, moves the charged particles downstream to be collected at the downstream collector. Thus, the thermionic emitter 146 enables energy extraction from thermal energy, and can additionally enable energy extraction from kinetic energy, as continued ion collection at the downstream collector generates an electric field that opposes particle movement with the stream. The thermionic emitter 146 is preferably capable of generating ions at low temperatures (e.g. lower than 1000° C.), but can alternatively be capable of generating ions at higher temperatures. The thermionic emitter 146 preferably includes a conductor 147, such as a metal, and can additionally include an ion-emitting coating 148. The conductor 147 is preferably a thermal conductor. The ion-emitting coating 148 preferably has a low binding potential (work function). The ion-emitting coating 148 preferably coats all surfaces of the conductor 147, but alternatively coats select surfaces of the conductor 147, such as a single broad face. The ion-emitting coating 148 is preferably a nitrogen doped nano-crystalline diamond coating, but can alternatively be an indium coating, a doped coating that facilitates positive ion release from the thermionic emitter 146, any other suitable low temperature material for thermionic emission, an oxide, or any other suitable coating. The thermionic emitter 146 is preferably formed through microfabrication processes, but can alternatively be formed through stamping, laser cutting, or any other suitable manufacturing process. The coating 148 is preferably deposited onto the conductor surface through chemical methods or physical methods, but can alternatively be grown over the conductor surface (e.g. using thermal oxidization). Examples of methods that can be used include thin-film deposition (e.g. plating, sputtering, chemical solution deposition, spin coating, chemical vapor deposition, atomic layer deposition, thermal evaporation, laser deposition, etc.), dip-coating, epitaxy, roll-to-roll coating, or any other suitable coating method.

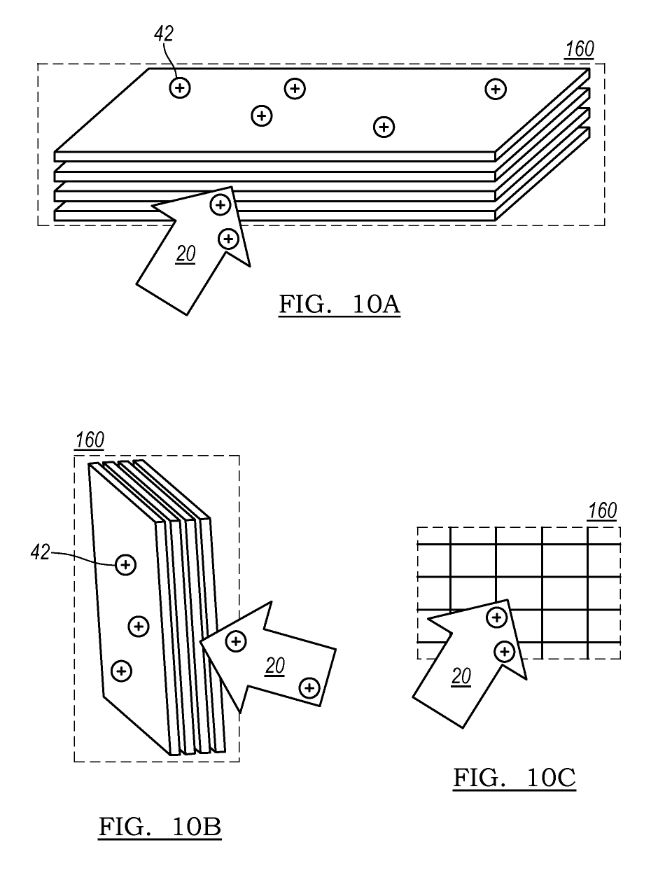

As shown in FIG. 7, the thermionic emitter 146 is preferably oriented with the longitudinal axis of the thermionic emitter 146 parallel to the longitudinal axis of the exhaust flue and/or direction of exhaust stream flow, but can alternatively be oriented with its longitudinal axis perpendicular to the longitudinal axis of the exhaust flue, or oriented at any suitable angle relative to the longitudinal axis of the exhaust flue. The thermionic emitter 146 is preferably located proximal the flue outlet within the flue, but can alternatively be located in any suitable position within the exhaust stream. The thermionic emitter 146 is preferably a prismatic plate, but can alternatively be a wire, tube, or any other suitable configuration. As shown in FIG. 9B, the surface of the thermionic emitter 146 is preferably smooth, but can alternatively include emitter features that can substantially increase charge flow from the thermionic emitter and increase local field strength proximal the thermionic emitter 146, thus enabling a field emission contribution to the charge density. The emitter features are preferably sharp features, and end in a point or an edge, but can alternatively be rounded or flat features. The emitter features preferably extend perpendicularly from a broad face of the emitter 146, but can alternatively extend from the emitter face at any suitable angle. Emitter features can include cones (shown in FIGS. 9A and 9C), frustro-conical structures, bumps (shown in FIG. 9D), grooves, or any other suitable feature that can increase the surface area of the thermionic emitter 146. Emitter features are preferably on the order of microns, (e.g. 30 micrometers in diameter), but can alternatively be larger or smaller.

The thermionic emitter 146 is preferably heated by the high-temperature exhaust stream flowing past, but can alternatively be heated by any other suitable means. The thermionic emitter 146 can additionally include heat conductors that function to conduct heat to the thermionic emitter 146. In this manner, the thermionic emitter 146 can additionally function as a heat sink. The heat conductors preferably include conductive material, such as metals. The heat conductors are preferably thermal connections, but can alternatively include fins or any other suitable apparatus that assists in heat collection. The heat conductors can conduct heat from heat-generating components within the exhaust stream-generating system, such as combustion beds or moving components. The heat conductors can also conduct heat from heated components within the system, such as components closer to the exhaust flue inlet. Alternatively, the heat conductors can conduct heat from any suitable component that has a higher temperature than the thermionic emitter 146.

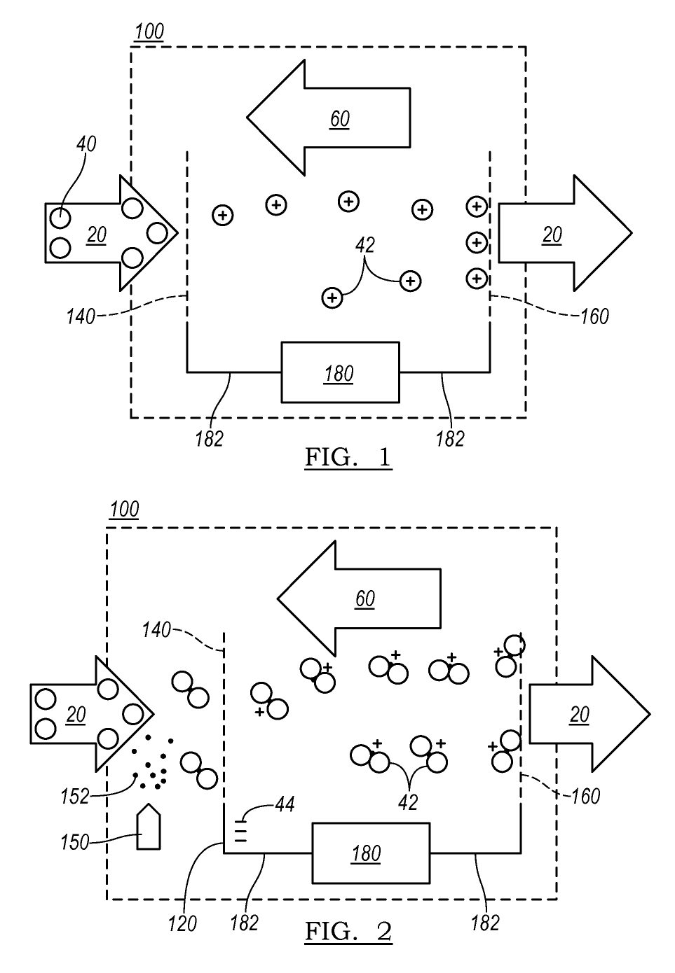

As shown in FIG. 2, the ionizer 140 can additionally include an upstream collector 120, which functions to create the electric field 60 that opposes the movement of the charged particle 42 as the particle is carried within the exhaust stream 20. To accomplish this, the upstream collector 120 is biased at an upstream potential, wherein the upstream potential is preferably the opposite polarity as the generated charged particles 42. For example, if positive charged particles 42 are created and carried by the exhaust stream 20, the upstream collector 120 is preferably biased at a negative potential. The upstream collector 120 is preferably arranged upstream from the ionizer 140 to minimize particle shorting to the upstream collector 120, but can alternatively be, or be a portion of, the ionizer 140. The upstream collector 120 is preferably conductive, and additionally functions to accumulate the ionic species that is not carried by the exhaust stream 20. In the above example, the upstream collector 120 preferably accumulates negative species 44, created when the positive charged particles 42 are generated. In doing so, the upstream potential can become more biased toward the upstream polarity. The upstream collector 120 is preferably a fluid permeable mesh, but can alternatively be a stack of vertically oriented plates, a section of the exhaust/flue 102, a toroidal collector (as shown in FIG. 2) or any suitable form that permits fluid flow therethrough. The upstream collector 120 is preferably the ionizer 140, but can alternatively be a portion of the ionizer 120 or a separate component from the ionizer.

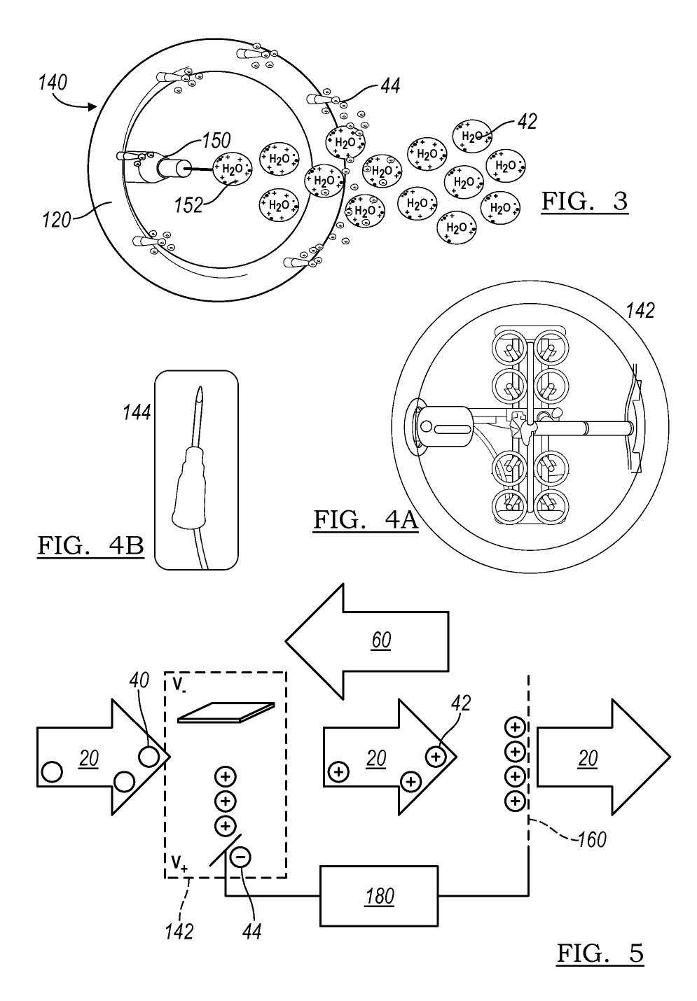

As shown in FIGS. 2 and 3, the ionizer 140 can additionally include a particle conditioner 150 that functions to adjust the particle resistivity and particle size distribution. The particle conditioner 150 can be desirable because particle ionization is sensitive to particle resistivity and size distribution. The particle conditioner 150 is preferably an injector that injects an additive 152 into the exhaust stream 20, wherein the additive 152 preferably aggregates or separates the exhaust particles 40 into more desirable (e.g. easily charged) particle clusters. For example, the additive 152 can entrain or attract multiple particles to create a particle cluster. The additive 152 can additionally assist in particle adherence to the downstream collector 160, or assist in subsequent particle removal from the downstream collector 160. Such additives 152 include solvents such as water and/or alkaline material, such as acidic gasses, sulfur trioxide, hydrated lime or soda ash. However, any suitable exhaust stream additive 152 can be used. The distribution and quantity of the additive 152 are preferably altered real time to achieve ideal particle distribution for the ionizer 140, but can alternatively be passive or static. The particle conditioner 150 preferably includes sensors, disposed upstream of the ionizer 140, that detect particle characteristics (e.g. humidity, temperature, average particle size, etc.) and a processor that adjusts the additive injection into the exhaust stream 20. The particle conditioner 150 can alternatively include only a processor and an injector, wherein the processor adjusts the additive injection based on information from the exhaust system (e.g. the type and amount of VOCs being exhausted, the painting stage currently being exhausted).

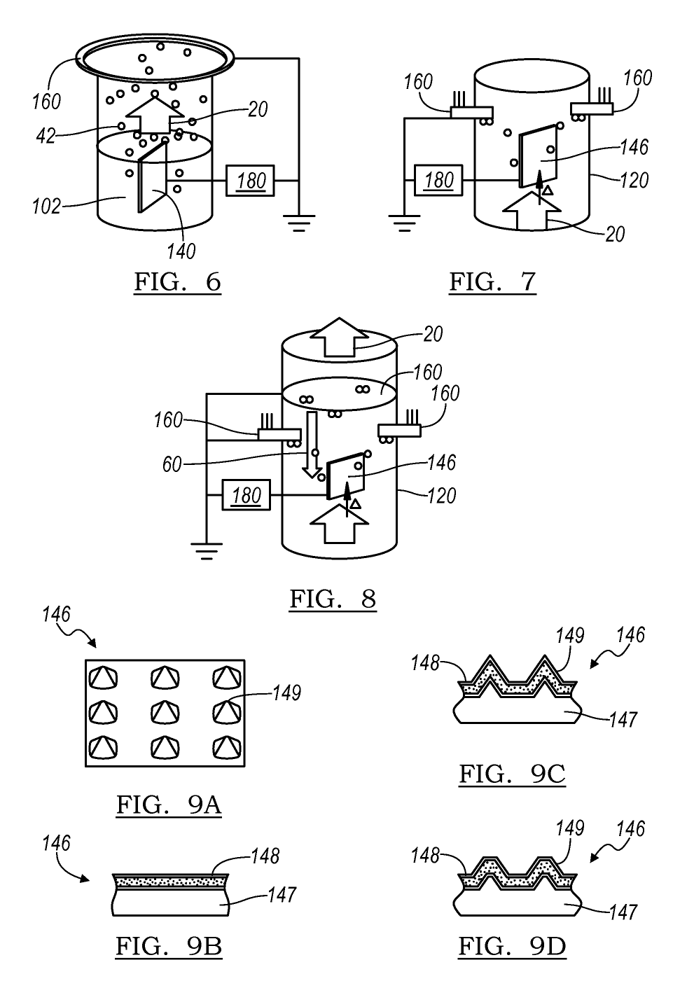

As shown in FIG. 1, the downstream collector 160 of the energy conversion system 100 functions to collect the charged particles 42 entrained within the exhaust stream 20. By collecting the charged particles 42, the downstream collector 160 accomplishes two goals. First, entrained particles 42 are removed from the exhaust stream 20, and prevented from being exhausted into ambient air. Second, as the downstream collector 160 collects additional charges, the potential difference between the downstream collector 160 and the upstream collector 120 increases, allowing more energy to be extracted from the system. The downstream collector 160 is preferably located downstream from the ionizer 140 within the exhaust stream. The downstream collector 160 is preferably located within the exhaust flue 102, but can alternatively be located external the exhaust flue 102 (as shown in FIG. 6). The downstream collector 160 is preferably located a fixed distance away from the ionizer 140, but the distance between the ionizer 140 and the downstream collector 160 can alternatively be adjustable. The downstream collector 160 is preferably grounded to electrical ground, but can be biased at the same polarity as the charged particle as the downstream collector 120 accumulates more charged particles. For example, the downstream collector 160 can become biased at a positive potential if positive particles are entrained within the exhaust stream 20. The downstream collector 160 preferably includes a large surface area exposed to the exhaust stream 20 to collect the charged particles 42, and is preferably conductive, but can alternatively be made of material with electrostatic properties. The downstream collector 160 preferably has a lower temperature than the ionizer 140, but can alternatively be held at the same temperature as the ionizer 140. The system 100 preferably includes a single downstream collector 160, but alternatively includes multiple downstream collectors. In one variation, the downstream collector 160 includes a stack of horizontal prismatic plates with gaps between the plates (as shown in FIG. 10A). In another variation, the downstream collector 160 includes a stack of vertical prismatic plates with gaps between the plates (as shown in FIG. 10B). In another variation, the downstream collector 160 includes a stack of curved plates. In another variation, the downstream collector 160 includes a mesh, oriented perpendicular to the longitudinal axis of the exhaust flue and/or the exhaust stream flow (as shown in FIG. 10C). The downstream collector 160 preferably has a diameter or surface area larger than the exhaust flue outlet, but can alternatively have a similar or smaller diameter or surface area. The downstream collector 160 is preferably coaxially arranged with the exhaust flue, but can alternatively be arranged eccentric to the exhaust flue. In another variation, the downstream collector 160 includes a metal filter or a HVAC filter, preferably disposed perpendicular to, but alternatively parallel to, the exhaust stream flow. In another variation, the downstream collector 160 includes the sides of the flue 102, wherein the exhaust flue 102 can be grounded or isolated from electrical ground. However, the downstream collector 160 can include the ground outside the exhaust system or any other suitable downstream collector 160.

In variations of the system 100 including a thermionic emitter 146, the downstream collector 160 associated with the thermionic emitter 146 is preferably maintained at a lower temperature than the thermionic emitter 146. Furthermore, the downstream collector 160 is preferably located close to the thermionic emitter 146 to prevent ion escape. The downstream collector 160 is preferably located on the order of tens of centimeters (e.g. 30 cm) from the thermionic emitter 146, but can alternatively be located further or closer. The downstream collector 160 is preferably passively cooled, but can alternatively be actively cooled (e.g. with a fan, piezoelectric element, etc.). The downstream collector 160 is preferably passively cooled by, and thermally coupled to, the ambient environment. The downstream collector 160 can additionally include heat-conducting elements, such as fins or grooves that facilitate increased cooling of the downstream collector 160. Alternatively/additionally, the downstream collector 160 can be a cold plate or tube, and can contain a volatile fluid therein that transports fluid to the cooling mechanism or a cooling area (e.g. by cycling between a hot downstream collector portion and a cool downstream collector portion).

In one variation of the system, as shown in FIG. 7, the downstream collector 160 extends perpendicularly from the flue interior through the flue wall thickness to thermally couple to the flue exterior. In another variation of the system, the downstream collector 160 extends along the flue length to couple to the flue exterior. In this variation, the cold plate variant of the downstream collector 160 can be particularly desirable if the system 100 is oriented vertically. In another variation of the system, the downstream collector 160 includes a collar that couples to the flue outlet, wherein the collar preferably includes heat-conducting elements (e.g. fins). In another variation of the system, the downstream collector 160 is located exterior the exhaust flue, preferably within one to two meters of the exhaust flue outlet, but alternatively closer or further away.

The system 100 can additionally include a regeneration mechanism which functions to regenerate the downstream collector 160. The regeneration mechanism preferably removes the collected particles 42 from the downstream collector 160. In one variation of the system 100, the regeneration mechanism oxidizes the collected particles 42. The regeneration mechanism can be a heating element that heats the downstream collector 160 to a predetermined oxidizing temperature, catalysts, a downstream burner, or any other suitable oxidizing mechanism. A processor preferably controls regeneration mechanism heating. The temperature is preferably dependent on the types of particles entrained within the exhaust stream 20, but can alternatively be agnostic of the particle type. In this variation, the downstream collector is preferably made of ceramic, more preferably electroceramic. However, the downstream collector can alternatively be made of metal, a ceramic-metal composite, or any other suitable material. In this variation, the system 100 can additionally include a manifold fluidly coupling the regeneration mechanism and/or downstream collector 160 to an oxygen supply. The oxygen supply can be the ambient environment, an oxygen tank, or any other suitable oxygen supply. In another variation of the system 100, the regeneration mechanism enables the downstream collector 160 to be removed from the exhaust flue 102, such that the downstream collector 160 can be cleaned. In this variation, the regeneration mechanism preferably includes slots through the exhaust flue walls through which the downstream collector 160 can be removed. In another variation of the system 100, the regeneration mechanism physically removes the collected particles 42 from the downstream collector 160 (e.g. by scraping, washing, etc.). However, the system 100 can include any other suitable regeneration mechanism for the downstream collector 160.

The load 180 of the energy conversion system 100 functions to extract electrical energy from the energy conversion system 100. The load 180 is preferably electrically coupled between the upstream collector 120 and the downstream collector 160, wherein the electrical couple 182 allows flow of an ionic species between the upstream and downstream collectors. The ionic species flows between the upstream and downstream collectors due to the potential difference created when the entrained species was charged by the ionizer 140; for example, when the ionizer 140 imparts a positive charge on a particle, a negative charge is also created, which is collected by the ionizer 140. The positively charged particle is carried away from the negative particle by the exhaust stream 20, and is eventually collected by the downstream collector 160, resulting in an increased potential difference between the ionizer 140 and downstream collector 160. By electrically coupling the ionizer 140 and the downstream collector 160 together, the electrical couple 182 allows the positive and negative particles to recombine, wherein flow of the negative particles towards the positive particles creates a current. The load 180, electrically coupled to the electrical couple 182, converts this current into electrical energy. The load 180 is preferably a resistive load 180, and is preferably coupled to a DC/DC converter, but can alternatively be coupled to a DC/AC converter. The load 180 can alternatively be an adjustable load 180, wherein the load 180 controls the potential difference between the upstream and downstream collector 160 by adjusting how much power is pulled from the system. The electrical couple 182 is preferably a wire, but can alternatively be the side of the flue 102 or the ground. However, the load 180 and the electrical couple 182 can alternatively be any suitable load 180 and electrical couple 182.

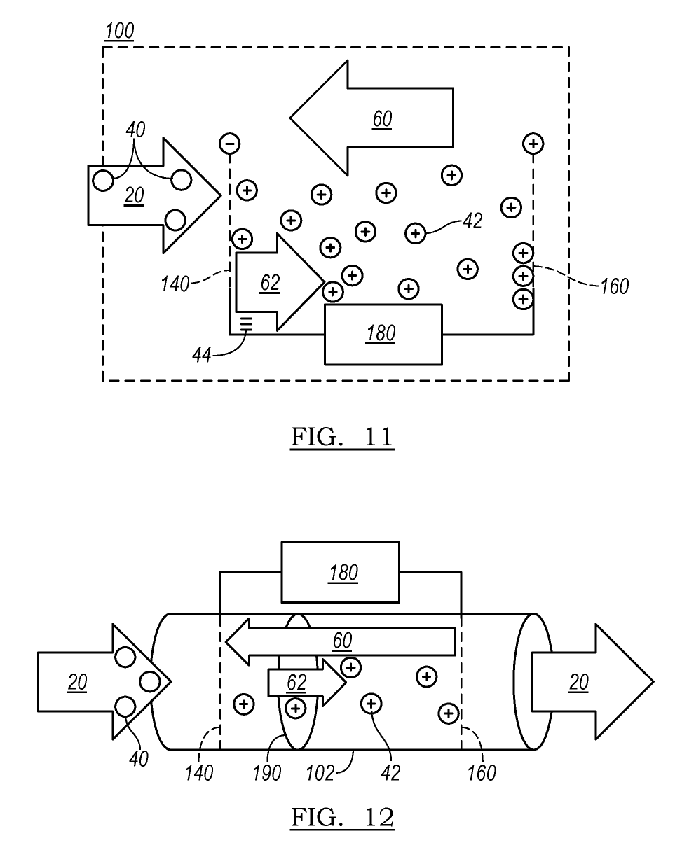

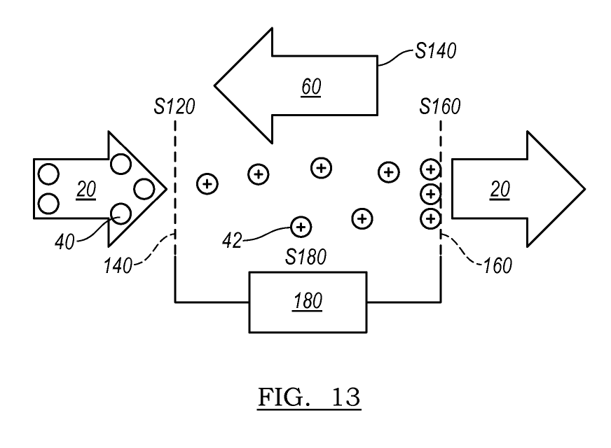

As shown in FIG. 11, the energy conversion system 100 can additionally include a field shaper 190 that functions to control the space charge generated near the ionizer 140 during operation. Due to the induced electric field 60, charged particles 42 can tend to form a charged space with a space charge near the ionizer 140. This space charge can be problematic as it can interfere with the charging process, resulting in minimized induced particle charge, and the particles creating the space charge can short to the ionizer 140, reducing overall energy extraction. The field shaper preferably minimizes the space charge occurrence by changing the shape of the induced electric field 60. More preferably, the field shaper functions to diffuse the space charge by reversing the electric field in the immediate vicinity of the ionizer 140. In one variation of the system 100, the field shaper generates a second electric field 62 (shaping field) that preferably reverses the electric field near the ionizer 140, and causes the net electric field to fall to substantially zero at a predetermined point downstream from the injector (minimum field point). The field shaper is preferably that described in U.S. Provisional 61/394,298, filed 18 Oct. 2010, titled “A System And Method For Controlling Electric Fields In Electro-Hydrodynamic Applications,” which is incorporated in its entirety by this reference. However, the field shaper can alternatively be any suitable field shaper. In one variation of the system, the field shaper includes electrodes, disposed downstream from the ionizer 140 within the exhaust stream 20, that attract the charged particles 42 away from the ionizer 140. These electrodes are preferably biased at a high enough potential that charged particles 42 are attracted to them, but are preferably small enough such that they do not collect charged particles 42 (e.g. the particles are accelerated towards the electrodes at a high enough speed that they bypass the electrodes entirely). Alternatively, the electrodes can include a localized repelling charge. These electrodes can include the shielding element and low curvature electrode of the corona discharge device 142, or can be electrodes that are separate components from the ionizer 140. In another variation of the system 100, as shown in FIG. 12, the field shaper includes a circumscribing electrode that encircles a portion of the exhaust stream 20 downstream from the ionizer 140. In this variation, the electrode is preferably a portion of the exhaust flue 102, more preferably embedded along the interior perimeter of an exhaust flue cross-section. The circumscribing electrode preferably generates an electric field concentrated along its central axis. In another variation of the system 100, the field shaper includes a magnet, located upstream of the ionizer 140, that generates a shaping field concentrated at a point downstream from the ionizer 140. However, the field shaper can be arranged within the exhaust flue 102, external the exhaust flue 102, or in any suitable location.

The system 100 can additionally include a processor that controls system 100 operation. The processor preferably functions as a voltage controller that minimizes electric sparking and arc generation by controlling the ionizer potential. The voltage controller is preferably responsive, wherein the ionizer potential is rapidly lowered upon detection of an adverse event (e.g. arcing or sparking), but can alternatively actively control particle charging, wherein the voltage controller alters the ionizer potential based on particle characteristics or periodically alters the ionizer potential to minimize the chance of an adverse event occurrence. The voltage controller is preferably a processor coupled to spark or voltage sensors, wherein the processor controls the voltage between the ionizer 140 and downstream collector 160. The processor can additionally control particle conditioning by controlling the particle conditioner 150. The processor can additionally control downstream collector regeneration by controlling the exhaust stream speed, downstream collector temperature, or any other suitable aspect of downstream collector regeneration. The processor can additionally control the distance between the system components, such as the distance between the ionizer 140 and the downstream collector 160. The processor can additionally control the amount of power extracted by the system by controlling the load. The processor is preferably that of the system that produces the exhaust stream 20, but can alternatively be a processor specific to the energy conversion system 100, or a processor shared between any suitable systems.

In one variation, as shown in FIG. 1, the system 100 includes an electrical ionizer 142 and a downstream collector 160 located downstream from the electrical ionizer 142. The system 100 functions to extract kinetic energy from the exhaust stream 20. The electrical ionizer 142 is preferably a corona discharge device or an induction charger, and creates unipolar charged particle 42 that are entrained within the exhaust stream 20 flowing past. The ionizer preferably additionally generates an electric field 60, wherein stream drag on the charged particle 42 at least partially opposes the force of the electric field 60 on the particle. The downstream collector 160 can include a stack of prismatic plates, wherein the downstream collector 160 is oriented such that the stacking direction is perpendicular to the longitudinal axis of the exhaust flue. The downstream collector 160 is preferably grounded, but can alternatively be held at the same polarity as the charged particle 42. The potential difference between the ionizer and downstream collector 160 is preferably controlled by a processor to maximize energy extraction efficiency. As shown in FIG. 12, the system 100 can additionally include a field shaper 190, disposed between the ionizer and downstream collector 160, that controls the space charge by generating a second electric field 62 opposing the first. The system 100 can additionally include a load, disposed between the downstream collector 160 and ionizer, that converts the potential difference into electrical energy. The processor can additionally adjust the resistance of the load to control the amount of power withdrawn from the system 100, and to control the potential difference between the ionizer and the downstream collector 160. The system 100 is preferably located near the inlet of the exhaust flue, but can alternatively be located near the exhaust flue outlet or at an intermediary point between the exhaust flue inlet and outlet.

In another variation, as shown in FIG. 7, the system 100 includes a thermionic emitter 146 as the ionizer and a downstream collector 160. The system 100 functions to convert thermal energy to electrical energy. The thermionic emitter 146 includes a low temperature material for thermal emission, such as a nitrogen doped nano-crystalline diamond coating, wherein the thermionic emitter 146 emits ions upon heating beyond a predetermined temperature threshold (e.g. the work function of the thermal emission material). The thermionic emitter 146 is preferably heated by the exhaust stream 20 flowing past, but can alternatively/additionally receive heat from other heat sources. The downstream collector 160 is preferably located a short distance downstream from the emitter, preferably on the order of tens of centimeters away from the emitter (e.g. within 30 cm), but can alternatively be located closer or further. The downstream collector 160 is preferably held at a lower temperature than the thermionic emitter 146, and is preferably passively cooled by a thermal connection to the flue exterior. The downstream collector 160 is preferably a thermally conductive pin that extends perpendicularly from the flue interior, through the flue wall, to the flue exterior, but can alternatively be a mesh or any suitable downstream collector 160. The system 100 can additionally include a load, electrically connected between the thermionic emitter 146 and the downstream collector 160, that converts the potential difference between the downstream collector 160 and the thermionic emitter 146 into electric energy.

In a third variation, as shown in FIG. 8, the system 100 includes a thermionic emitter 146, a first downstream collector 160, and a second downstream collector 160. The first downstream collector 160 is preferably arranged proximal the thermionic emitter 146, preferably within thirty centimeters downstream of the thermionic emitter 146, but alternatively further. The temperature of the first downstream collector 160 is preferably maintained at a lower temperature than the thermionic emitter 146, preferably by passive cooling through thermal coupling to the ambient environment. The first downstream collector 160 preferably collects the majority of the ions created by the thermionic emitter 146, and harvests the thermal energy of the exhaust stream 20. The second downstream collector 160 is preferably located further downstream than the first downstream collector 160, more preferably located beyond the exhaust flue outlet. The second downstream collector 160 preferably collects the ions that escape collection by the first downstream collector 160. The second downstream collector 160 is preferably biased at the same polarity as the emitted ions, and harvests a portion of the kinetic energy of the exhaust stream 20. The first and second downstream collector 160 are preferably electrically connected in parallel, but can alternatively be electrically connected in series. Parallel connection of the first and second downstream collector 160 can reduce the need for an electric field 60 generator to bias the second downstream collector 160 at a different potential from the ionizer; collection of unipolar ions released by the thermionic emitter 146 biases the first downstream collector 160 at a potential of the same polarity as the ions, and parallel connection between the first and second downstream collector 160 allows the second downstream collector 160 to be biased at the same potential as the first downstream collector 160, generating the electric field 60 required to extract kinetic energy from the system 100. The first and second downstream collector 160 are preferably electrically connected in series with a load and the thermionic emitter 146, but can alternatively be electrically connected in parallel.

In a fourth variation, the system 100 is substantially similar to the third variation, but includes an electrical ionizer 142 in addition to the thermionic emitter 146. The thermionic emitter 146 is preferably paired with the first downstream collector 160 to form a first subsystem 100. The first downstream collector 160 is preferably thermally coupled to the ambient environment. The electrical ionizer 142 is preferably paired with the second downstream collector 160 to form a second subsystem 100, and is preferably located downstream from the first subsystem 100. The electrical ionizer 142 is preferably held at an upstream potential that generates an electric field 60 that at least partially opposes charged particle 42 movement with the exhaust stream 20. In operation, the first subsystem 100 extracts thermal energy from the system 100. The thermionic emitter 146 preferably uses the heat of the exhaust stream 20 to ionize some of the entrained particles flowing past, wherein the particles ionized by the thermionic emitter 146 are preferably collected by the first downstream collector 160. The second subsystem 100 extracts kinetic energy from the exhaust stream 20. The electrical ionizer 142 ionizes at least a portion of the uncollected particles, wherein the second downstream collector 160 collects the particles ionized by the electrical ionizer 142. The electrical ionizer 142 preferably produces ions of the same polarity as the thermionic emitter 146. In this variation, both downstream collectors 160 are preferably grounded and connected in series to their respective ionizers and loads.

### 2. Method for Energy and Particle Extraction

As shown in FIG. 13, a method of volumetric exhaust energy extraction includes charging particles entrained within the exhaust stream to a single polarity S120, collecting the charged particle downstream S140, and applying a load to the induced potential from the entrained particle S160. The method can additionally include generating an electric field, stream drag on the charged particle at least partially opposing the force of the electric field on the particle S130. The method functions to convert the thermal and/or kinetic energy of the exhaust stream into electricity, as well as to remove particles from the exhaust stream. The method is preferably used with the apparatus as described above, but can alternatively utilize any suitable apparatus, such the ones described in Ser. No. 12/357,862, filed 22 Jan. 2009, titled “Electro-Hydrodynamic Wind Energy System” and prior PCT application number PCT/US09/31682, filed 22 Jan. 2009, titled “Electro-Hydrodynamic Wind Energy System” which are both incorporated in their entirety by this reference. The method can additionally be controlled by a processor, wherein the processor preferably evaluates the efficiency of particle removal from the exhaust stream and/or the energy extraction efficiency and in response to the evaluation, adjusts the parameters of the apparatus (e.g. potentials at which components are biased, applied load, particle size distribution or resistivity, distance between components, etc.).

Charging particles entrained within the exhaust stream to a single polarity S120 functions to charge one or more particles already entrained within the exhaust stream. These particles are preferably the byproducts of industrial processes. For example, the particle can be volatile organic compounds (VOCs) that are byproducts of automotive paint processes, or water particle clusters that are byproducts of regenerative thermal oxidization processes. An ionizer preferably charges the entrained particles flowing within the exhaust stream, wherein some, preferably all, of the entrained particles flowing past the ionizer are preferably charged to a given polarity (e.g. given a positive or negative charge). Entrained particles are preferably positively charged, but can alternatively be negatively charged, and are preferably charged below or near the point at which the ratio between electrostatic and drag forces on the charged particle are equal, while ensuring that drag forces always exceed electrostatic forces for the specified wind stream. For gaseous species, the charge should approach the point at which ion mobility and stream velocity are equal while allowing stream velocity to exceed ion mobility. The ionizer can be an electrical ionizer, such as a corona discharge device or an induction charger, but can alternatively be a thermionic emitter or any other suitable ionizer. The ionizer preferably simultaneously charges a cross section of the exhaust stream, but can alternatively simultaneously charge a volume of the exhaust stream or any other suitable portion of the exhaust stream. Charging the particle preferably creates two particles: a first particle that is entrained within and carried away by the exhaust stream, and a second particle of opposite charge to the first that is collected by the ionizer or an upstream collector. In one variation, charging the particle includes producing a corona discharge. The corona discharge is preferably a positive corona that charges the particles to a positive polarity, but can alternatively be a negative corona that charges the particles to a negative polarity. In operation, a corona discharge device ionizes the particles entrained within the exhaust stream as the particles flow past the corona. In another variation, charging the particle includes emitting ions from a thermionic emitter. Emitting ions from a thermionic emitter preferably includes heating the thermionic emitter above the work function of the thermionic emitter, more preferably heating the thermionic emitter above the work function of a thermionic emitter coating. The thermionic emitter is preferably heated by heat from the exhaust stream flowing past, converting exhaust stream heat into ions. The thermionic emitter can alternatively be heated by and convert heat from other system components and/or processes, heaters, or any other suitable heat source into ions. In operation, the emitted ions charge a portion of the particles entrained within the exhaust stream (e.g. water molecule clusters) as the particles flow past the thermionic emitter.

Charging a particle can additionally include conditioning the entrained particles. This is preferably accomplished by introducing an additive into the exhaust stream, preferably upstream of the ionizer, that adjusts the particle size distribution and/or particle resistance within the exhaust stream. The additive can be introduced by injection into the exhaust stream (e.g. by a nozzle), but can alternatively be introduced by evaporation from an additive bed or any other suitable method of introducing liquid or solid particles into the exhaust stream.

The method can additionally include generating an electric field S120, which functions to provide an electric field against which the kinetic energy of the exhaust stream can do work. The generated electric field preferably applies a force on the charged particle that opposes stream drag on the particle. The generated electric field can also hinder charged particle collection at the downstream collector by hindering charged particle motion toward the downstream collector. The electric field is preferably generated between the ionizer or upstream collector and the downstream collector. The electric field can be generated by biasing the ionizer at a potential having a polarity opposite that of the charged particles. For example, when the entrained particles are charged to a positive polarity, the ionizer or upstream collector can be biased at a negative potential. Alternatively/additionally, the electric field can be generated by collecting the charged particles at the downstream collector. In operation, a potential difference is induced between the ionizer or upstream collector and the downstream collector as the ionizer/upstream collector collects the second, orphaned charge species and the downstream collector collects the first particle that entrained within the exhaust stream. For example, the potential difference between the ionizer/upstream collector and downstream collector can increase during operation as the ionizer/upstream collector collects the orphaned negative charges while the downstream collector collects the positively charged particles. The electric field can alternatively/additionally be generated by biasing the downstream collector at a potential having a polarity similar to that of the charged particles. For example, the downstream collector can be held at a positive polarity when the particles are positively charged. However, any other suitable method of generating an electric field can be used. The strength of the generated electric field is preferably controlled such that stream velocity slightly exceeds ion mobility.

Collecting the charged particles downstream S140 functions to precipitate particles from the exhaust stream. A downstream collector, such as a plate stack, a mesh, or a filter is preferably positioned downstream from the ionizer within the exhaust pipe. The particles preferably collide and stick to the downstream collector, and are preferably retained on the downstream collector by electrostatic pressure. Collecting the charged particles can additionally include cooling the downstream collector, such as thermally coupling the downstream collector to the ambient environment to passively cool the downstream collector, or activating a fan to actively cool the downstream collector.

Collecting the charged particles downstream can additionally include removing the collected particles from the downstream collector. Removing the collected particles from the downstream collector can include oxidizing the particles with the downstream collector. Oxidizing the particles with the downstream collector can include heating the downstream collector to a predetermined temperature, including catalysts that react with the particles, or any other suitable method of oxidizing the particles with the downstream collector. Removing the particles from the downstream collector can alternatively/additionally include periodically purging the particles from the downstream collector. Periodically purging the particles from the downstream collector can include increasing the exhaust stream flow rate to a purge flow rate, flowing a solvent over the downstream collector, or any other suitable method of purging particles from the downstream collector. This variation can additionally include oxidizing the purged particles, which can include flowing the purged particles through a burner or catalyst bed. Removing the particles from the downstream collector can additionally/alternatively include cleaning the downstream collector. Cleaning the downstream collector can include removing the downstream collector from the exhaust flue and scrubbing, rinsing, or otherwise removing the particles from the downstream collector.

Applying a load to the induced potential from the entrained particle S160 functions to convert the potential created by displacement of charged particles into electrical energy. The load is preferably applied between the ionizer or upstream collector and a point downstream, preferably the downstream collector, and preferably electrically couples the two points. The load preferably converts the built up charge of the system (the induced potential) into useable power by pulling a current, resulting from the induced potential, from the system. The load can additionally store the energy, transmit the energy, convert the energy, or otherwise use the energy for any suitable purpose.

The method can additionally include controlling a space charge near the ionizer. Controlling the space charge near the ionizer can include generating a second electric field that opposes the first electric field, which can function to at least partially disperse a space charge near the ionizer that is generated by the charged particles. However, the space charge can be controlled using any suitable method. The second electric field preferably opposes the first electric field, and preferably reverses the net electric field a predetermined distance away from the ionizer. The second electric field is preferably generated by a field shaper or electric field generator. The field shaper can be a pair of oppositely charged electrodes that remotely attract but locally repel the charged particles; a circumscribing electrode located downstream from the ionizer or upstream collector that generates a second electric field; a magnet located upstream from the ionizer or upstream collector that generates a second electric field concentrated at a point downstream from the ionizer/upstream collector; or any other suitable field shaper. The field shaper can be incorporated as a portion of the exhaust flue, or can be a separate component.

The method can additionally include dynamically adjusting the parameters of the system. A processor preferably actively adjusts the system parameters in response to a threshold condition being met, but the system parameters can alternatively be passively adjusted. Threshold conditions can include: the amount of entrained particulates upstream from the system increasing beyond a concentration threshold, the amount of entrained particulates downstream from the system increasing beyond a concentration threshold, the amount of extracted power increasing beyond or falling below a power threshold, or any other suitable threshold condition indicative of system performance. The processor can adjust the potential at which the ionizer or upstream collector is biased, the magnitude of the ionizer potential, the distance between the ionizer and downstream collector, the amount and/or type of additive injected into the exhaust stream, the magnitude of the second electric field generated by the field shaper, the amount of particle removal from the downstream collector, the amount of power pulled from the system, the frequency at which power is pulled from the system, and any other suitable parameter of the system. The processor can additionally adjust the parameters of the exhaust stream generating system, such as the exhaust stream flow rate, the particle concentration within the exhaust stream, or any other suitable parameter.

In one variation of the method, an exhaust stream parameter is measured and ionizer operation is selectively controlled in response to the exhaust stream parameter measurement. The measured parameter is preferably the exhaust stream temperature, wherein a processor initiates corona discharge in response to the exhaust stream temperature falling below a predetermined threshold (e.g. the temperature at which thermal energy overcomes the work function of the thermionic emitter), and ceases corona discharge when the exhaust stream temperature exceeds the predetermined threshold. However, ionizer operation can be controlled based on exhaust stream flow rate, pressure, or any other suitable parameter.

As a person skilled in the art will recognize from the previous detailed description and from the figures and claims, modifications and changes can be made to the preferred embodiments of the invention without departing from the scope of this invention defined in the following claims.

We claim:

1. A system for energy and particle extraction from an exhaust stream containing entrained particles, the system comprising:
an ionizer configured to charge the particles within the exhaust stream to a first charge polarity, and to generate an electric field that at least partially opposes motion of the particles with the exhaust stream;
a downstream collector, disposed downstream from the ionizer, configured to collect the charged particles; and
an electrical couple, configured to electrically couple a load between the ionizer and the downstream collector that converts kinetic energy of the exhaust stream into electric power.

2. The system of claim 1, further comprising an electric field generator configured to generate a second electric field that opposes the first electric field, such that the net electric field at a predetermined distance downstream from the ionizer is approximately zero.

3. The system of claim 2, wherein the electric field generator is disposed between the ionizer and the downstream collector.

4. The system of claim 4, wherein the electric field generator comprises a circumscribing electrode comprising a circumscribing segment of an exhaust flue through which the exhaust stream flows.

5. The system of claim 1, wherein the ionizer comprises a thermionic emitter configured to emit ions into the exhaust stream when heated.

6. The system of claim 5, wherein the thermionic emitter comprises a plate, arranged such that the exhaust stream flows parallel to a broad face of the plate.

7. The system of claim 6, wherein the thermionic emitter comprises nitrogen doped nano-crystalline diamond coating.

8. The system of claim 6, wherein the thermionic emitter comprises emitter features.

9. The system of claim 6, wherein the downstream collector comprises cooling features.

10. The system of claim 9, wherein the downstream collector is arranged perpendicular to the exhaust stream.

11. The system of claim 1, wherein the ionizer comprises a positive corona discharge device.

12. The system of claim 1, wherein the ionizer is configured to inject an additive into the exhaust stream that adjusts the particle size distribution within the exhaust stream.

13. A system for energy and particle extraction from an exhaust stream, comprising:
an ionizer configured to release unipolar ions upon absorption of thermal energy from the exhaust stream;
a downstream collector, disposed downstream from the ionizer, configured to have a temperature lower than that of the ionizer and to collect particles charged by the ions; and
an electrical couple configured to electrically couple a load between the ionizer and the downstream collector.

14. The system of claim 13, wherein the ionizer comprises a thermionic emitter.

15. The system of claim 14, wherein the thermionic emitter comprises a prismatic plate comprising a plurality of emitter features extending perpendicularly from a broad face.

16. The system of claim 14, wherein the thermionic emitter comprises a nitrogen doped nano-crystalline diamond coating.

17. The system of claim 13, wherein the downstream collector comprises a passively cooled downstream collector configured to extend perpendicular to exhaust stream flow.

18. The system of claim 17, wherein the downstream collector encloses a volatile liquid that cycles between a hot downstream collector portion and a cool downstream collector portion to cool the downstream collector.

19. A system for energy and particle extraction from an exhaust stream containing particles, comprising:
an ionizer configured to release unipolar ions of a first polarity upon absorption of thermal energy from the exhaust stream, wherein the ions charge the particles;
a first downstream collector, disposed downstream from the ionizer, configured to have a temperature lower than that of the ionizer and to collect charged particles;
a second downstream collector, disposed downstream from the first downstream collector, configured to cooperatively generate an electric field with the ionizer that opposes ion movement with the exhaust stream and to collect charged particles; and
an electrical couple configured to electrically couple a load between the ionizer and the first and second downstream collectors.

20. The system of claim 19, wherein the ionizer comprises a thermionic emitter.

21. The system of claim 19, further comprising a second ionizer, the second ionizer comprising an electrical ionizer, the second ionizer disposed between the first and second downstream collector, the second ionizer configured to charge the particles within the exhaust stream to the first charge polarity, and to cooperatively generate an electric field with the second downstream collector that at least partially opposes motion of the particles with the exhaust stream.
